(19) United States
(12) Patent Application Publication
(10) Pub. No.: US 2011/0285804 A1
(43) Pub. Date: Nov. 24, 2011

(54) IMAGE FORMING APPARATUS

(76) Inventor: Yoshihiro ESUMI, Tokyo (JP)

(21) Appl. No.: 13/108,668

(22) Filed: May 16, 2011

(30) Foreign Application Priority Data
May 19, 2010 (JP) 2010-114942

(51) Int. Cl. B41J 2/435

(52) U.S. Cl. 347/224

(57) ABSTRACT

Disclosed is an image forming apparatus that makes it possible to cope with the deviations in the main-scanning direction when the image forming velocity has been changed. The apparatus includes: a light source; a polygon mirror; a start-position light detecting section to detect a light beam at a main-scanning start point; a stop-position light detecting section to detect the light beam at a main-scanning stop point; a measuring section to measure a time difference between times when the start-position light detecting section and the stop-position light detecting section detect the light beam; a magnification correction data creating section to create magnification correction data for every rotation number of the polygon mirror, based on the main-scanning time; and a magnification factor correcting section to adjust interval distances between positions of exposed dots so as to correct the magnification factor in the main-scanning direction by using the magnification correction data.

This application is based on Japanese Patent Application NO. 2010-114942 filed on May 19, 2010, with Japan Patent Office, the entire content of which is hereby incorporated by reference.

### BACKGROUND OF THE INVENTION

The present invention relates to an image forming apparatus, such as a copier, a printer, etc., and specifically relates to an image forming magnification adjusting operation of an image forming apparatus that is provided with a function for scanning a laser beam emitted from a light source onto a recording medium, such as a photosensitive member, etc., by employing a rotating polygon mirror, so as to write an image onto the recording medium concerned.

There has been well-known such an image forming apparatus that conducts a main-scanning operation for scanning a light beam, intensity of which is modulated on the basis of image data, onto a photosensitive member in a main-scanning direction so as to form a one scanning line image, while repeats the abovementioned main-scanning operation by incrementally moving the photosensitive member in a sub-scanning direction every time when the image forming operation for one scanning line image is completed, in order to form a whole image for one page.

As an example of the abovementioned, in the image forming apparatus employing the electrophotographic method, the image is formed on a photoreceptor member (photoreceptor drum) by scanning a laser beam, intensity of which is modulated on the basis of the image data, onto the photoreceptor drum in the main-scanning direction, while rotating the photoreceptor drum in the sub-scanning. In this example, the intensity of the laser beam is modulated by the image data with reference to a clock signal (write clock), called “dot clock pulse”.

Further, in order to conduct a high-speed image forming operation, there has been also well-known such an image forming apparatus that is provided with a plurality of light sources, including two or more laser diodes or the like, so as to employ plural laser beams, emitted from the plurality of light sources, for repeating the main-scanning operations to form one scanning line images respectively corresponding to the plural laser beams while incrementally moving the photosensitive member in the sub-scanning direction to form a whole image for one page. The abovementioned multi-beam type image forming apparatus is set forth in, for instance, Tokkai 63-124664 (Japanese Patent Application Laid-Open Publication), etc.

In order to achieve a high quality image forming operation in such the multi-beam type image forming apparatus as abovementioned, it is important to align both the main-scanning start points and the main-scanning stop points of the plural laser beams respectively with each other. In other words, it becomes important to eliminate deviations in the main-scanning direction between the plural laser beams.

For instance, Tokkai 2005-208323 and Tokkai 2002-182139 (both are Japanese Patent Application Laid-Open Publication) set forth various kinds of methods for eliminating the abovementioned deviations in the main-scanning direction.

However, as a result of the intensive investigations conducted by the present inventor and his colleagues, the present inventor found that the problems to be described in the following still remain unsolved, even if the concerned image forming apparatus is adjusted by employing any one or any combination of the methods, set forth in the above-cited patent documents, so as to eliminate the deviations in the main-scanning direction.

At first, for instance, there exists such a technology for lowering the image forming velocity (line velocity) to a level lower that the normal image forming velocity when an image is to be formed onto a thick paper sheet, so as to maintain (secure) the toner fixing efficiency of the fixing device. In other words, the technology makes it possible to change both the main-scanning velocity and the sub-scanning velocity at the time of changing the image forming velocity. In this connection, since the main-scanning velocity is determined by the number of rotations of the polygon mirror, the change of the main-scanning velocity is to change the number of rotations of the polygon mirror.

In this connection, since the lower the rotation number of the polygon mirror is, the lower the stability of the rotating action of the polygon mirror becomes, jitter components will increase. Owing to the increased jitter components, the deviations in the main-scanning direction are liable to occur.

On the other hand, as a result of actual measurements with respect to the relationships between the rotation number of the polygon mirror and the jitter components, it has been revealed that an amount of jitter components is not simply in inverse proportion or reciprocal proportion to the rotation number of the polygon mirror as indicated in the jitter characteristic (transition of amount of jitter components versus rotation number of polygon mirror) shown in FIG. 8. Further, in addition to the above, it has been also revealed that the jitter value and the inclination property included in the jitter characteristic vary between the different motors, even if the same polygon mirror is employed.

Still further, when the rotation number of the polygon mirror is changed, it has been also revealed that, with respect to the jitter characteristic of each of the mirror surfaces as shown in FIG. 9, an amount of jitter components is not in inverse proportion or reciprocal proportion to the rotation number of the polygon mirror, even when the same combination of the photoreceptor member and the motor is employed. In the concrete example shown in FIG. 9, the jitter characteristics of the fifth surface exhibits such a tendency that is different from those of the other surfaces. It could be assumed that this tendency would be caused by the fluctuations generated depending on whether or not different-type vibrations are generated in response to the changes of the number of rotations, in relation to various kinds of factors, such as a deviation of rotating axis, weight balances between mechanical parts, a resonance action with the number of rotations, etc.

According to the prior art technology set forth in Tokkai 2005-208323 (Japanese Patent Application Laid-Open Publication) aforementioned, a main-scanning positional deviation amount measured in advance is stored in a storage device, so that the main-scanning start point is regionally shifted for every main-scanning operation according to the main-scanning positional deviation amount stored in the storage device. In this connection, according to the abovementioned technology, since the main-scanning start point is shifted merely in a unit of one clock period, there has been such a drawback that it is impossible to set the deviation amount at a value equal to or smaller than its half amount.

Further, according to the prior art technology set forth in Tokkai 2005-208323, since the correction processing is carried out merely by employing the main-scanning positional deviation amount measured in advance, there has been such a problem that it is impossible to cope with the abovementioned change of the jitter, occurring at the time when the rotation number of polygon mirror has changed.

Still further, according to the prior art technology set forth in Tokkai 2002-182139 (Japanese Patent Application Laid-Open Publication) aforementioned, a scanning duration time for a single main-scanning operation or plural main-scanning operations is measured, and then, a period and a amplitude of a variation transition curve of the scanning duration time above-measured are calculated. Successively, the write clock is made to change, so as to cancel the above-calculated result.

Further, even according to the other prior art technology set forth in Tokkai 2002-182139, since the correction processing is carried out merely by employing the period and the amplitude of the variation transition curve of the scanning duration time measured in advance, there has been such a problem that it is impossible to cope with the abovementioned change of the jitter, occurring at the time when the rotation number of polygon mirror has changed.

### SUMMARY OF THE INVENTION

To overcome the abovementioned drawbacks in conventional image forming apparatus, it is one of objects of the present invention to provide an image forming apparatus, which makes it possible to cope with the deviations in the main-scanning direction when the image forming velocity has been changed.

Accordingly, at least one of the objects of the present invention can be attained by any one of the image forming apparatuses described as follows.
(1) According to an image forming apparatus reflecting an aspect of the present invention, the image forming apparatus provided with such an image forming function that an operation for exposing an image onto an image bearing member is conducted by scanning a light beam, which is modulated based on image data representing the image to be formed, onto the image bearing member in a main-scanning direction, while moving the image bearing member relative to the light beam in a sub-scanning direction orthogonal to the main-scanning direction, and the image forming apparatus being capable of conducting an image forming operation in any one of plural image forming modes, image forming velocities of which are different from each other, by changing both a scanning velocity in the main-scanning direction and a driving velocity in the sub-scanning direction, the image forming apparatus comprises: a light source to emit the light beam; a polygon mirror, having a plurality of reflection surfaces, to scan the light beam onto the image bearing member in the main-scanning direction by rotating the plurality of reflection surfaces; a start-position light detecting section, disposed at a main-scanning start point located within a beginning side region of the main-scanning direction, to detect the light beam at the main-scanning start point; a stop-position light detecting section, disposed at a main-scanning stop point located within an ending side region of the main-scanning direction, to detect the light beam at the main-scanning stop point; a measuring section to measure a time difference between a time when the start-position light detecting section detects the light beam at the main-scanning start point and another time when the stop-position light detecting section detects the light beam at the main-scanning stop point, wherein the time difference is defined as a main-scanning time; a magnification correction data creating section to create magnification correction data, which is to be used for correcting a magnification factor in the main-scanning direction so as to keep each of main-scanning lengths of the light beam, deflected by each of the reflection surfaces, constant, for every rotation number of the polygon mirror, based on the main-scanning time; and a magnification factor correcting section to adjust interval distances between positions of exposed dots represented by the image data so as to correct the magnification factor in the main-scanning direction by using the magnification correction data corresponding to the rotation number of the polygon mirror.
(2) According to another aspect of the present invention, in the image forming apparatus recited in item 1, the magnification factor correcting section adjusts a clock frequency of clock signals to be employed for modulating the light beam based on the image data, in order to adjust the interval distances between the positions of the exposed dots represented by the image data.
(3) According to still another aspect of the present invention, in the image forming apparatus recited in item 1 or 2, the light source is capable of emitting a plurality of light beams aligned in the sub-scanning direction; and each of the plurality of light beams is modulated based on corresponding one of main-scanning line image data sets, which represent main-scanning line images being adjacent to each other and are included in the image data
(4) According to still another aspect of the present invention, in the image forming apparatus recited in any one of items 1-3, the scanning velocity in the main-scanning direction is determined by a rotation velocity of the polygon mirror, while the rotation velocity is determined corresponding to the driving velocity in the sub-scanning direction.
(5) According to still another aspect of the present invention, in the image forming apparatus recited in any one of items 1-4, the main-scanning start point, at which the start-position light detecting section detects the light beam, is arranged on an extension line extended into the beginning side region from a main-scanning position of the image bearing member, and the main-scanning stop point, at which the stop-position light detecting section detects the light beam, is arranged on another extension line extended into the ending side region from the main-scanning position of the image bearing member.
(6) According to still another aspect of the present invention, the image forming apparatus, recited in any one of items 1-5, further comprises: a reflection surface specifying section configured to specify an arbitral reflection surface among the reflection surfaces of the polygon mirror; wherein, referring to a specific reflection surface specified by the reflection surface specifying section and synchronizing with a main-scanning timing of the specific reflection surface, the magnification correction data creating section creates the magnification correction data, and then, the magnification factor correcting section corrects the magnification factor in the main-scanning direction by using the magnification correction data
(7) According to yet another aspect of the present invention, in the image forming apparatus recited in any one of items 1-6, the magnification correction data creating section creates the magnification correction data, when the scanning velocity in the main-scanning direction and the driving velocity in the sub-scanning direction are changed.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a block diagram indicating a configuration of an image forming apparatus embodied in the present invention as the first embodiment;

FIG. 2 shows a flowchart indicating a flow of operations to be conducted in an image forming apparatus embodied in the present invention as the first embodiment;

FIG. 3 shows an explanatory schematic diagram indicating characteristics (before correction) of an image forming apparatus embodied in the present invention as the first embodiment;

FIG. 4 shows an explanatory schematic diagram indicating characteristics (before correction) of an image forming apparatus embodied in the present invention as the first embodiment;

FIG. 5 shows an explanatory schematic diagram indicating characteristics (before correction) of an image forming apparatus embodied in the present invention as the first embodiment;

FIG. 6 shows an explanatory schematic diagram indicating characteristics (after correction) of an image forming apparatus embodied in the present invention as the first embodiment;

FIG. 7 shows a flowchart indicating a flow of calibrating operations to be conducted by a main section of an image forming apparatus embodied in the present invention as the first embodiment;

FIG. 8 shows a characteristic graph indicating a transition of amount versus change of an image forming velocity; and

FIG. 9 shows a characteristic graph indicating another transition of jitter amount versus change of reflection surfaces with respect to two image forming velocities serving as a parameter.

### DETAILED DESCRIPTION OF THE PREFERRED EMBODIMENT

Now, referring to the drawings, the preferred embodiments for implementing the present invention will be detailed in the following. The exemplified image forming apparatus, embodied in the present invention, is provided with such an image forming function that the operation for exposing an image onto an image bearing member is conducted by scanning a light beam, which is modulated on the basis of image data representing the image to be formed, onto the image bearing member in its main-scanning direction, while incrementally moving the image bearing member relative to the light beam in a sub-scanning direction orthogonal to the main-scanning direction, and is capable of conducting the image forming operation in any one of plural image forming modes, image forming velocities of which are different from each other, by changing both the main-scanning velocity and the sub-scanning velocity at a time.

### <Configuration>

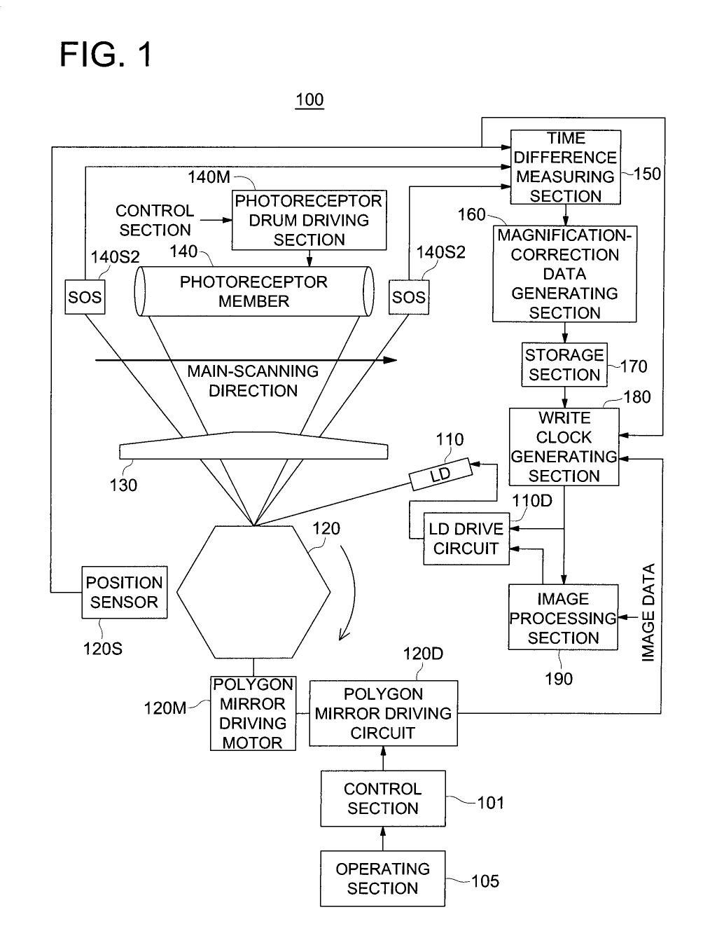

Referring to the block diagram shown in FIG. 1, an electrical system configuration of an image forming apparatus 100, embodied in the present invention as the first embodiment, will be detailed in the following. Incidentally, with respect to the first embodiment, the structural elements necessary for correcting the deviations in the main-scanning direction in the exposing operation employing the laser beam will be mainly detailed in the following. Accordingly, the explanations for the other structural elements, which are generally employed in the image forming apparatus and well known to a skilled person in the art, will be omitted.

A control section 101 is constituted by a CPU (Central Processing Unit) for controlling various kinds of sections provided in the image forming apparatus 100, controlling programs, etc., so as to specifically conduct the controlling operation described in the following, in addition to the conventional image forming operations. Concretely speaking, the control section 101 creates magnification correction data, which is to be used for correcting the magnification factor in the main-scanning direction so as to keep the main-scanning length for every reflection surface of the polygon mirror constant, based on the result of measuring the time difference between the time when the laser beam is detected at the main-scanning start point and the other time when the laser beam is detected at the main-scanning stop point (main-scanning duration time), and stores the created magnification correction data therein, for every rotation number of polygon mirror, and then, employs the magnification correction data corresponding to the rotation number of polygon mirror, so as to conduct an operation for correcting the magnification factor in the main-scanning direction by adjusting the interval distances between exposed positions represented by the image data.

An operating section 105 serves as an operation inputting device, from which the operator can input various kinds of instructions in regard to the image forming operation to be performed. The contents of the instructions inputted by the operator are transmitted from the operating section 105 to the control section 101. In this connection, when the operator designates a thick paper sheet, thickness of which is greater than that of a normal paper sheet, as the kind of paper sheet to be employed for the image forming operation, the control section 101 conducts such a controlling operation for changing the current image forming velocity to the low image forming velocity being lower than the normal image forming velocity.

A laser diode 110 serves as a light source to emit a laser beam (light beam) to be scanned onto a photoreceptor drum so as to conduct an exposing operation. In this connection, for this purpose, either a single laser beam or a plurality of laser beams may be applicable in the present invention.

A LD (laser diode) drive circuit 110D serves as a driving source that creates a light emission drive signal for driving the light emitting action of the laser diode 110, so as to supply the light emission drive signal to the laser diode 110, and supplies the light emission drive signals, modulated according to the concerned image data, to the laser diode 110. In this connection, when the laser diode 110 emits a plurality of laser beams aligned in the sub-scanning direction and modulated by image data being adjacent to each other in the sub-scanning direction, the LD drive circuit 110D creates the light emission drive signals corresponding to the plurality of laser beams and supplies them to the laser diode 110.

A polygon mirror 120 is structured as a rotating multi-surface mirror device for sequentially scanning the laser beam reflected by each of the plural reflection surfaces onto the photoreceptor drum in the main-scanning direction. A polygon mirror driving motor 120M serves as a rotation driving device that receives a polygon mirror driving signal to make the polygon mirror 120 rotate at a predetermined rotation number. A polygon mirror driving circuit 120D serves as a polygon-mirror driving signal generating section that generates the polygon mirror driving signal for making the polygon mirror 120 rotate at a predetermined rotation number and feeds it to the polygon mirror driving motor 120M. In this connection, the polygon mirror driving circuit 120D generates such the polygon mirror driving signal that makes the rotation number of the polygon mirror 120 correspond to the image forming velocity determined by the control section 101.

A position sensor 120S serves as a reflection surface specifying unit to read a reference position mark attached onto either a reflection surface or a center shaft, so as to generate an identification signal for identifying each of the plural reflection surfaces of the polygon mirror 120, and sends the identification signal to a time difference measuring section, detailed later.

An optical system 130 is constituted by various kinds of optical parts, such as a cylindrical lens, a collimator lens, an f-θ lens, etc., so as to scan the laser beam, which has been emitted from the laser diode 110 and reflected by each of the reflection surfaces of the polygon mirror 120, onto the photoreceptor drum at a predetermined main-scanning velocity.

A photoreceptor drum 140 serves as an image bearing member, onto which an electrostatic latent image is formed, and then, is developed with toner so as to from a visual toner image thereon, wherein the electrostatic latent image is formed by exposing the laser beam currently scanned onto the circumferential surface of the photoreceptor drum 140 in the main-scanning direction in conjunction with the rotating actions of the polygon mirror 120, while by rotating the photoreceptor drum 140 in the sub-scanning direction being orthogonal to the main-scanning direction. In this connection, the image forming apparatus 100 also employs such the conventional processes for forming an image onto a recording paper sheet, including a charging process for forming an electrostatic latent image, a toner image forming process by developing the electrostatic latent image above-formed, a transfer process for transferring the toner image onto the recording paper sheet, a fixing process for fixing the toner image onto the recording paper sheet, etc., which have been conventionally employed by various kinds of general purpose image forming apparatuses. Accordingly, hereinafter, explanations for such the conventional processes will be omitted.

A photoreceptor drum driving section 140M serves as a photoreceptor drum rotation driving section to make the photoreceptor drum 140 rotate in the sub-scanning direction at the predetermined rotation number. In this connection, the photoreceptor drum driving section 140M drives the rotation of the photoreceptor drum 140 so as to make the rotation number of the photoreceptor drum 140 correspond to the image forming velocity determined by the control section 101.

A start-position light detecting section 140S1 serves as a light beam detecting sensor to detect a light beam at a main-scanning start position located on an extension line extended form the main-scanning line to be scanned onto the photoreceptor drum 140, and transmits the detected result to the time difference measuring section, detailed later. On the other hand, an end-position light detecting section 140S2 serves as a light beam detecting sensor to detect a light beam at a main-scanning end position located on an extension line extended form the main-scanning line to be scanned onto the photoreceptor drum 140, and transmits the detected result to the time difference measuring section, detailed later. In this connection, it is preferable to find the dime difference (scanning time) by detecting the light beam at the abovementioned two points residing on the extension lines extended to the both sides of the main-scanning line to be scanned onto the photoreceptor drum 140, in order to find an accurate scanning time and an accurate magnification correction data.

A time difference measuring section 150 serves as a measuring section for measuring a scanning time required for scanning a predetermined distance between the start-position light detecting section 140S1 disposed at the scanning start side and the end-position light detecting section 140S2 disposed at the scanning end side, based on the time difference between the time when the start-position light detecting section 140S1 detects the light beam and the other time when the end-position light detecting section 140S2 detects the light beam, serving as the detected results.

Based on the scanning time measured by the time difference measuring section 150, a magnification-correction data generating section 160 creates the magnification correction data, which is to be used for correcting the magnification factor in the main-scanning direction so as to keep the main-scanning length for every reflection surface of the polygon mirror 120 constant, for every rotation number of polygon mirror 120. In this connection, referring to the specific reflection surface specified by the position sensor 120S, and synthesizing with the scan timing of each of the reflection surfaces, the magnification-correction data generating section 160 creates the magnification correction data for each of the reflection surfaces.

A storage section 170 serves as a storage device that stores the magnification correction data generated by the magnification-correction data generating section 160 for every rotation number of polygon mirror 120, therein.

A write clock generating section 180 generates a write pixel clock (hereinafter, referred to as a write clock), which becomes necessary at the time when the light emission driving signal for driving the light emitting action of the laser diode 110 is generated by the LD drive circuit 110D. In this connection, the write clock generating section 180 is also configured as a magnification factor correcting unit that adjusts the positional intervals between the exposed dots represented by the image data, while employing the magnification correction data corresponding to the rotation number of the polygon mirror, to adjust the frequency of the write clock so as to correct the magnification factor of the main-scanning direction. Further, in this connection, the write clock generating section 180, serving as the magnification factor correcting unit, makes it possible to adjust the positional intervals between the exposed dots represented by the image data so as to correct the magnification factor of the main-scanning direction by employing any one of various kinds of correcting methods, such as a PLL (Phase Locked Loop) method, a frequency modulation method, etc.

Still further, in this connection, referring to the specific reflection surface specified by the position sensor 120S, and synthesizing with the scan timing of each of the reflection surfaces of the polygon mirror 120, the write clock generating section 180 implements the operation for correcting the magnification factor for every reflection surface.

An image processing section 190 serves as an image processing unit for applying various kinds of image processing, necessary for implementing the consecutive image forming operations, to the image data concerned. Further, in the image processing section 190, synthesizing with the write clock, the necessary data is outputted to the LD drive circuit 110D. In this connection, when the plural laser beams, which are aligned in the sub-scanning direction and are modulated based on plural line image data sets representing images of scanning lines located adjacent to each other, are emitted by the laser diode 110, the corresponding plural line image data sets are outputted to the LD drive circuit 110D.

### <Operating Mode 1>

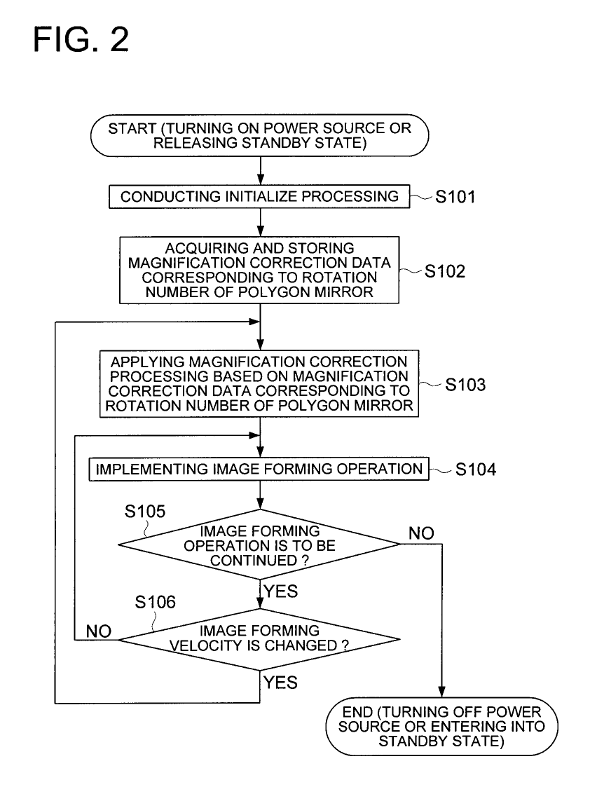

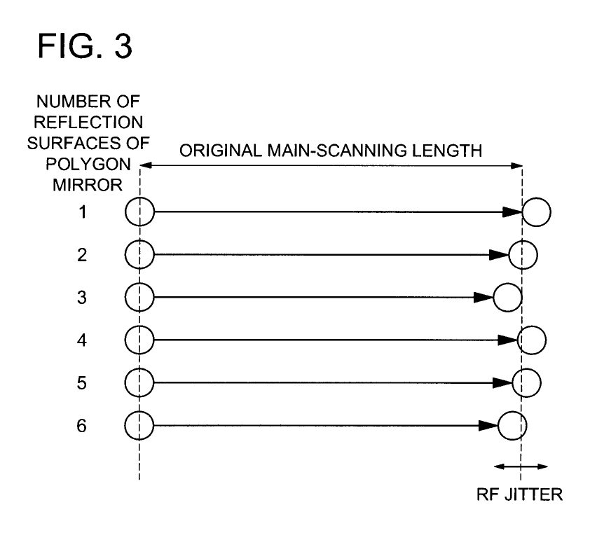

Referring to the flowchart shown in FIG. 2 and the explanatory schematic diagram shown in FIG. 3, the “OPERATING MODE 1” of the image forming apparatus 100, embodied in the present invention, will be detailed in the following.

In this connection, in the following descriptions, the polygon mirror 120 having six reflection surfaces will be exemplified as its concrete example, while, with respect to such a case that the laser diode 110 emits a plurality of laser beams, the laser diode 110 having a capability for emitting four laser beam will be exemplified as its concrete example.

On any one of the occasions for turning ON the power source of the image forming apparatus 100, releasing a standby state, such as a sleep mode, etc., and changing a writing unit provided with the light source and the polygon mirror, the control section 101 conducts the following operations. At first, the control section 101 initializes each of the various kinds of sections, and at the same time, activates the polygon mirror driving motor 120M through the polygon mirror driving circuit 120D, so as to make the polygon mirror driving motor 120M rotate at the predetermined rotation number (Step S101 shown in FIG. 2).

In this connection, since the operations to be conducted in the image forming apparatus 100 include various kinds of time consuming operations, such as the operation for controlling the toner density of the developer to be used in the developing device, the other operation for controlling the fixing temperature of the fixing device, etc., it takes a fixed time interval until all of the initializing operations have been completed.

Accordingly, using the abovementioned fixed time interval for conducting the initialize processing, the control section 101 conducts such the controlling operation for finding the magnification correction data to be used when correcting the magnification factor in the main-scanning direction, with respect to each of the rotation numbers of the polygon mirror 120, corresponding to the image forming velocities (line velocities) being changeable (selectable) according to the thickness of the recording paper sheet to be employed (Step S102 shown in FIG. 2).

For instance, it is assumed that, in order to stabilize the toner image fixing operation to be conducted in the fixing section, when the paper sheet having a normal thickness is employed, the image forming velocity (line velocity) is set at 400 mm/sec., while, when the paper sheet having a thickness thicker than the normal thickness (hereinafter, referred to as the thick paper sheet) is employed, the image forming velocity (line velocity) is set at 300 mm/sec. In this connection, although an example of the two steps change is indicated hereinafter, it is also applicable that the image forming velocity (line velocity) changes in three or more steps.

Initially, the control section 101 controls the polygon mirror driving motor 120M through the polygon mirror driving circuit 120D, so as to make the polygon mirror 120 rotate at 17716 rpm (hereinafter, defined as a “low speed rotation” in the present embodiment), corresponding to the image forming velocity (line velocity) of 300 mm/sec., when the thick paper sheet is employed.

Successively, when the polygon mirror 120 has entered into such a stable state that the polygon mirror 120 is constantly rotated at 17716 rpm by the polygon mirror driving motor 120M, with respect to the laser beam reflected by each of the reflection surfaces of the polygon mirror 120, the time difference measuring section 150 measures the scanning time of the predetermined distance between the start-position light detecting section 140S1 and the end-position light detecting section 140S2, based on the time difference between the time detected by the start-position light detecting section 140S1 and the other time detected by the end-position light detecting section 140S2, according to the instruction commands issued by the control section 101. In this connection, on the abovementioned occasion, in order to distinguish the reflection surface of the polygon mirror 120, which is currently under the measurement, the detected result outputted by the position sensor 120S is also taken into account.

Further, in this connection, when the polygon mirror 120 is provided with six reflection surfaces, it is assumed that the main-scanning length of each of the six reflection surfaces fluctuates due to the jitter component caused by various kinds of factors, as indicated in the schematic diagram shown in FIG. 3. On that occasion, when the main-scanning length is elongated as indicated by that of the first reflection surface or the fourth reflection surface, the scanning time of the predetermined distance between the start-position light detecting section 140S1 and the end-position light detecting section 140S2 becomes short. On the other hand, when the main-scanning length is shrunk as indicated by that of the third reflection surface or the sixth reflection surface, the scanning time of the predetermined distance between the start-position light detecting section 140S1 and the end-position light detecting section 140S2 becomes long. Namely, the expansion or contraction of the main-scanning length can be determined by measuring the concerned scanning time of the predetermined distance between the start-position light detecting section 140S1 and the end-position light detecting section 140S2.

Successively, based on the main-scanning time measured by the time difference measuring section 150, the magnification-correction data generating section 160 creates the magnification correction data for correcting the magnification factor in the main-scanning direction for every reflection surface of the polygon mirror 120, so as to keep the main-scanning length constant, corresponding to the image forming velocity of 300 mm/sec.

Still successively, the storage section 170 stores the magnification correction data, which has been created by the magnification-correction data generating section 160, so as to make it comply with the image forming velocity of 300 mm/sec for the thick paper sheet, corresponding to the low speed rotation of the polygon mirror 120, as the polygon-mirror magnification correction data for low speed rotation use.

Still successively, the control section 101 controls the polygon mirror driving motor 120M through the polygon mirror driving circuit 120D, so as to make the polygon mirror 120 rotate at 23622 rpm (hereinafter, defined as a “normal speed rotation” in this embodiment), corresponding to the image forming velocity (line velocity) of 400 mm/sec., which is to be employed when the normal paper sheet is employed.

Still successively, when the polygon mirror 120 has entered into such a stable state that the polygon mirror 120 is constantly rotated at 23622 rpm by the polygon mirror driving motor 120M, with respect to the laser beam reflected by each of the reflection surfaces of the polygon mirror 120, the time difference measuring section 150 measures the scanning time of the predetermined distance between the start-position light detecting section 140S1 and the end-position light detecting section 140S2, based on the time difference between the time detected by the start-position light detecting section 140S1 and the other time detected by the end-position light detecting section 140S2, according to the instruction commands issued by the control section 101. In this connection, on the abovementioned occasion, in order to distinguish the reflection surface of the polygon mirror 120, which is currently under the measurement, the detected result outputted by the position sensor 120S is also taken into account.

Still successively, based on the main-scanning time measured by the time difference measuring section 150, the magnification-correction data generating section 160 creates the magnification correction data for correcting the magnification factor in the main-scanning direction for every reflection surface of the polygon mirror 120, so as to keep the main-scanning length constant, corresponding to the image forming velocity of 400 mm/sec.

Still successively, the storage section 170 stores the magnification correction data, which has been created by the magnification-correction data generating section 160, so as to make it comply with the image forming velocity of 400 mm/sec for the normal recording paper sheet, corresponding to the normal speed rotation of the polygon mirror 120, as the polygon-mirror magnification correction data for normal speed rotation use.

Yet successively, at the time when the initialize processing (Step S101 shown in FIG. 2) and the operations for acquiring and storing the magnification correction data (Step S102 shown in FIG. 2) have been completed, the image forming apparatus 100 implements the image forming operation, in response to the instruction commands received from the operating section 105, an external personal computer, etc.

During the process of the image forming operation concerned, the control section 101 reads out the magnification correction data corresponding to the image forming velocity in conformity with the recording paper sheet to be currently used for the image forming operation from the storage section 170, and makes the write clock generating section 180 generate the write clock signals, the clock frequency of which is adjusted by employing the magnification correction data above-read, and then, feeds the above-adjusted write clock signals to the LD drive circuit 110D and the image processing section 190, in order to implement the image forming operation in such a state that the positional intervals between the exposed dots, represented by the image data, are adjusted so as to keep the main-scanning length constant by eliminating the jitter components (Step S103 and Step S104 shown in FIG. 2).

When the image forming operation is to be continued (Step S105; Yes, shown in FIG. 2), and the thickness of the paper sheet is not changed, and further, the image forming velocity (line velocity) is not changed (Step S106; No, shown in FIG. 2), the image forming operation is performed thereafter, in such a state that the same magnification correction data is still applied (Step S104 shown in FIG. 2).

On the other hand, when the image forming operation is to be continued with respect to the same job or a different job (Step S105; Yes, shown in FIG. 2), and since the thickness of the paper sheet is changed, and further, the image forming velocity (line velocity) is also changed (Step S106; Yes, shown in FIG. 2), the control section 101 reads out the magnification correction data corresponding to the recording paper sheet to be employed for the image forming operation, which is to be implemented in the state that the image forming velocity has been changed, from the storage section 170, and makes the write clock generating section 180 generate the write clock signals, the clock frequency of which is adjusted by employing the magnification correction data above-read, and then, feeds the above-adjusted write clock signals to the LD drive circuit 110D and the image processing section 190, in order to implement the image forming operation in such a state that the positional intervals between the exposed dots, represented by the image data, are adjusted so as to keep the main-scanning length constant by eliminating the jitter components (Step S103 and Step S104 shown in FIG. 2).

Thereafter, at the time when accepting the request for implementing another image forming operation, the control section 101 repeats the consecutive operations indicated in Step S103 through Step S106, until the image forming apparatus 100 is deactivated or made to enter into the sleeping mode (END shown in FIG. 2).

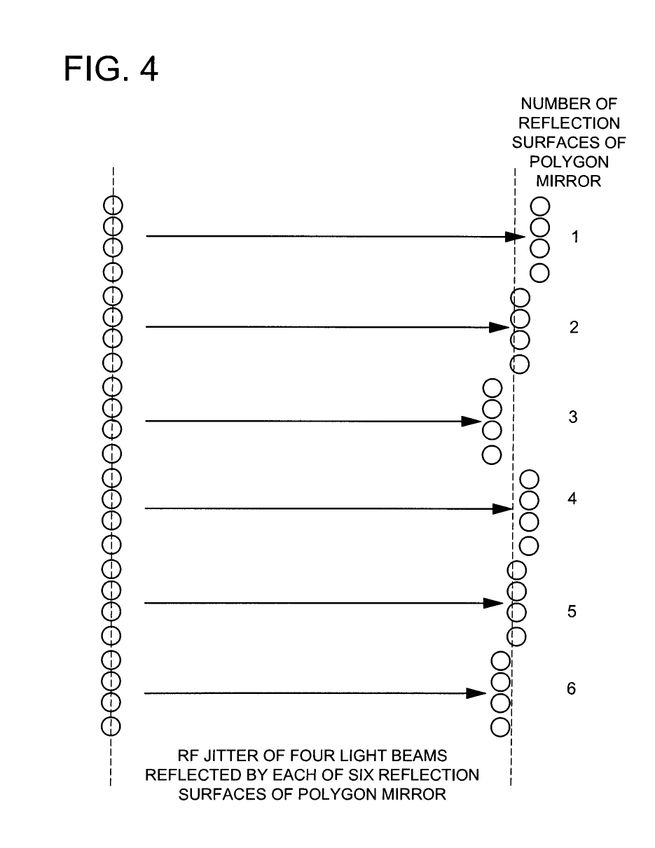

In this connection, when operations for scanning a plurality of line images at a time is implemented in the sub-scanning direction by employing a plurality of laser beams, if jitter components exist, the state indicated in the schematic diagram shown in FIG. 4 would emerge, even if the polygon mirror having the same number of reflection surfaces is employed. Concretely speaking, since the transition period of the jitter components is extended in the sub-scanning direction, corresponding to the number of the laser beams (number of the plural line images), the special frequency of the transition period will be lowered, resulting in such a state that the transition period of the jitter components become more recognizable then ever.

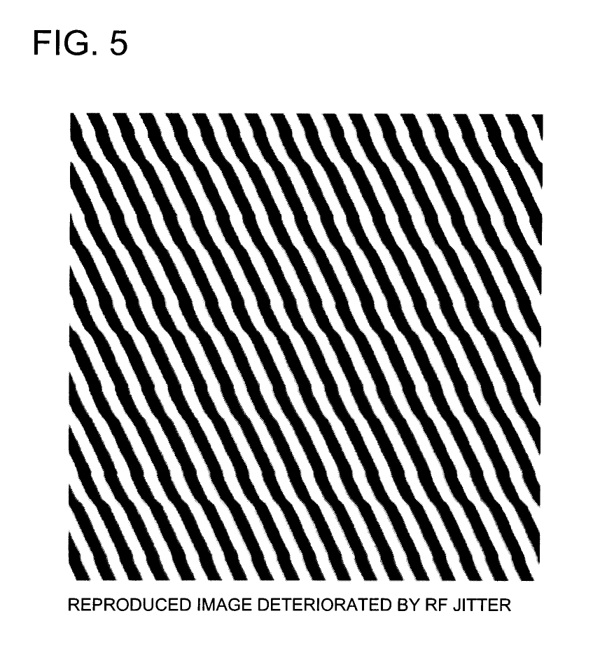

FIG. 5 shows a schematic diagram indicating an enlarged part of an inclined line pattern image, which is formed by scanning four laser beams at a time, in a conventional image forming apparatus in which the jitter components remain exist. As shown in FIG. 5, since the concerned image includes the jitter components being periodically repeated for every four laser beams, the transition of the jitter components becomes easily recognizable as deviations of the inclined line images.

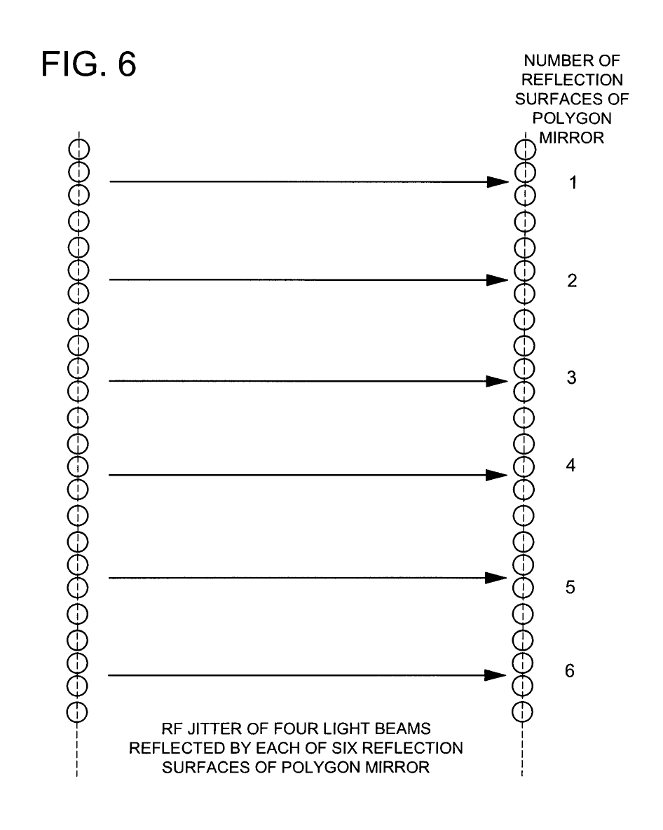

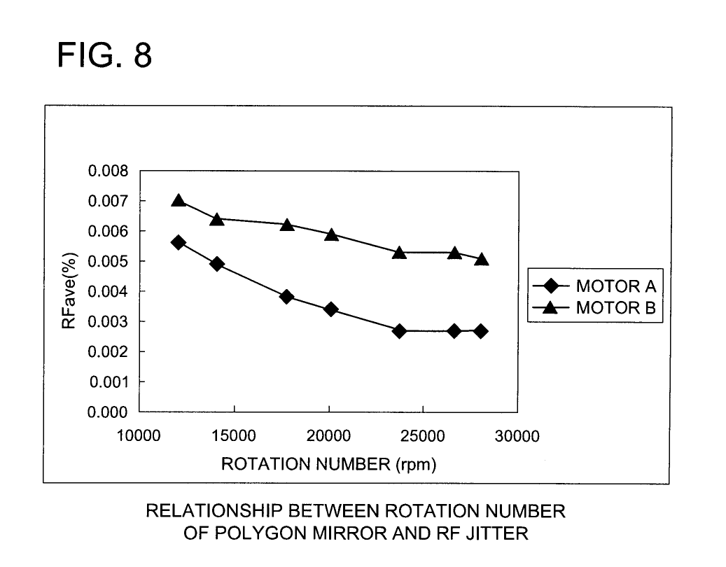

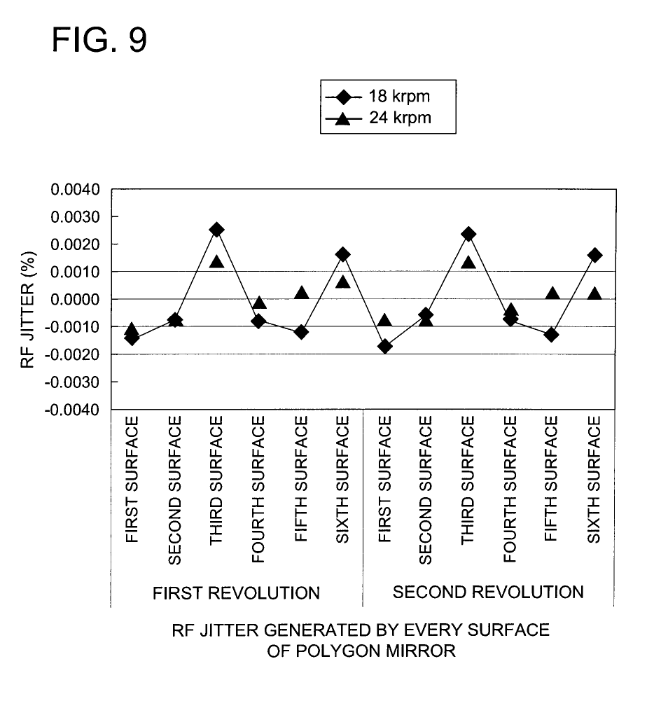

To solve the abovementioned problem, when the image forming apparatus, embodied in the present invention, is employed for the abovementioned image forming operation, since the jitter components shown in FIG. 4 can be corrected so as to keep the main-scanning length constant, it becomes possible to implement such the exposing operation that eliminates the jitter components from the formed image as indicated in the schematic diagram shown in FIG. 6. Accordingly, even if the rotation velocity of the polygon mirror has been changed in association with the change of the image forming velocity, it becomes possible to effectively eliminate the deviations of the formed image in the main-scanning direction, and as a result, it becomes possible to form a uniform image without being influenced by the change of the image forming velocity. In other words, although it has been impossible for a conventional image forming apparatus to cope with the characteristics of the jitter components, which is liable to vary depending on the change of the rotation number of the polygon mirror as shown in FIG. 8 and FIG. 9, according to the image forming apparatus, embodied in the present invention, it becomes possible to effectively eliminate the deviations of the formed image in the main-scanning direction, and as a result, it becomes possible to form a uniform image without being influenced by the change of the image forming velocity.

Further, when the image forming operation is conducted by employing the plural laser beams, which are aligned in the sub-scanning direction and are modulated based on plural line image data sets representing images of scanning lines located adjacent to each other, it becomes possible to securely eliminate the deviations in the main-scanning direction, which are visibly recognizable, and as a result, it becomes possible to form a uniform image without being influenced by the change of the image forming velocity.

### <Operating Mode 2>

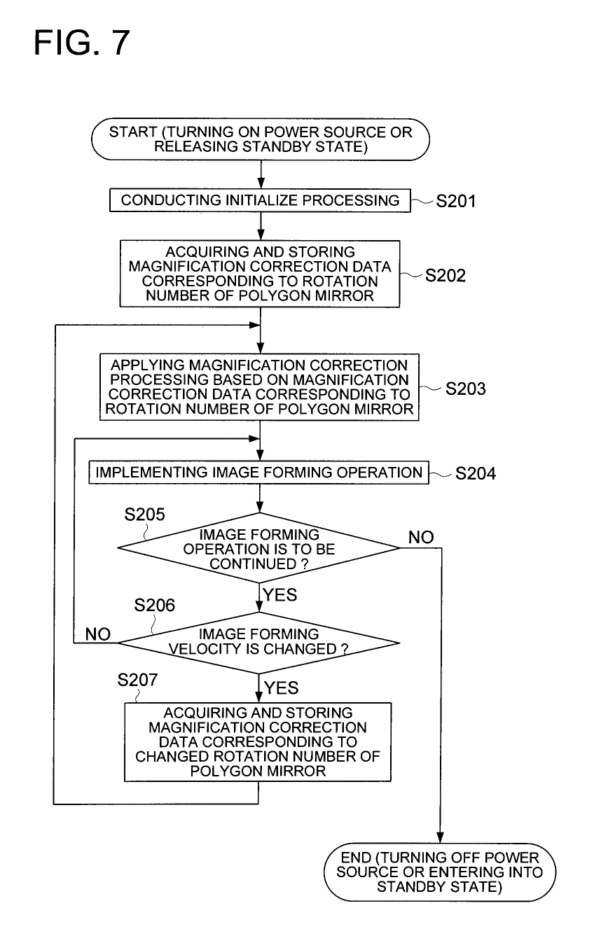

Referring to the flowchart shown in FIG. 7 and the explanatory schematic diagrams shown in FIG. 3 through FIG. 6, the “OPERATING MODE 2” of the image forming apparatus 100, embodied in the present invention, will be detailed in the following.

On any one of the occasions for turning ON the power source of the image forming apparatus 100, releasing a standby state, such as a sleep mode, etc., and changing a writing unit provided with the light source and the polygon mirror, the control section 101 conducts the following operations. At first, the control section 101 initializes each of the various kinds of sections, and at the same time, activates the polygon mirror driving motor 120M through the polygon mirror driving circuit 120D, so as to make the polygon mirror driving motor 120M rotate at the predetermined rotation number (Step S201 shown in FIG. 7).

In this connection, since the operations to be conducted in the image forming apparatus 100 include various kinds of time consuming operations, such as the operation for controlling the toner density of the developer to be used in the developing device, the other operation for controlling the fixing temperature of the fixing device, etc., it takes a fixed time interval until all of the initializing operations have been completed.

Accordingly, using the abovementioned fixed time interval for conducting the initialize processing, the control section 101 conducts such the controlling operation for finding the magnification correction data to be used when correcting the magnification factor in the main-scanning direction, with respect to the rotation number of the polygon mirror 120, corresponding to the image forming velocity (line velocity) to be employed for forming the image onto the normal recording paper sheet (Step 5202 shown in FIG. 7).

For instance, it is assumed that, in order to stabilize the toner image fixing operation to be conducted in the fixing section, when the paper sheet having a normal thickness is employed, the image forming velocity (line velocity) is set at 400 mm/sec., while, when the thick paper sheet is employed, the image forming velocity (line velocity) is set at 300 mm/sec. In this connection, although an example of the two steps change is indicated hereinafter, it is also applicable that the image forming velocity (line velocity) changes in three or more steps.

Initially, the control section 101 controls the polygon mirror driving motor 120M through the polygon mirror driving circuit 120D, so as to make the polygon mirror 120 rotate at 23622 rpm (hereinafter, defined as a “normal speed rotation” in the present embodiment), corresponding to the image forming velocity (line velocity) of 300 mm/sec., when the thick paper sheet is employed.

Successively, when the polygon mirror 120 has entered into such a stable state that the polygon mirror 120 is constantly rotated at 23622 rpm by the polygon mirror driving motor 120M, with respect to the laser beam reflected by each of the reflection surfaces of the polygon mirror 120, the time difference measuring section 150 measures the scanning time of the predetermined distance between the start-position light detecting section 140S1 and the end-position light detecting section 140S2, based on the time difference between the time detected by the start-position light detecting section 140S1 and the other time detected by the end-position light detecting section 140S2, according to the instruction commands issued by the control section 101. In this connection, on the abovementioned occasion, in order to distinguish the reflection surface of the polygon mirror 120, which is currently under the measurement, the detected result outputted by the position sensor 120S is also taken into account.

Successively, based on the main-scanning time measured by the time difference measuring section 150, the magnification-correction data generating section 160 creates the magnification correction data for correcting the magnification factor in the main-scanning direction for every reflection surface of the polygon mirror 120, so as to keep the main-scanning length constant, corresponding to the image forming velocity of 400 mm/sec.

Still successively, the storage section 170 stores the magnification correction data, which has been created by the magnification-correction data generating section 160, so as to make it comply with the image forming velocity of 400 mm/sec for the normal paper sheet, corresponding to the normal speed rotation of the polygon mirror 120, as the polygon-mirror magnification correction data for normal speed rotation use.

Yet successively, at the time when the initialize processing (Step S201 shown in FIG. 7) and the operations for acquiring and storing the magnification correction data (Step S202 shown in FIG. 7) have been completed, the image forming apparatus 100 implements the image forming operation, in response to the instruction commands received from the operating section 105, an external personal computer, etc.

During the process of the image forming operation concerned, the control section 101 reads out the magnification correction data corresponding to the image forming velocity in conformity with the normal recording paper sheet to be currently used for the image forming operation, and makes the write clock generating section 180 generate the write clock signals, the clock frequency of which is adjusted by employing the magnification correction data above-read, and then, feeds the above-adjusted write clock signals to the LD drive circuit 110D and the image processing section 190, in order to implement the image forming operation in such a state that the positional intervals between the exposed dots, represented by the image data, are adjusted so as to keep the main-scanning length constant by eliminating the jitter components (Step S203 and Step S204 shown in FIG. 7).

When the image forming operation is to be continued (Step S205; Yes, shown in FIG. 7), and the thickness of the paper sheet is not changed from that of the normal recording paper sheet, and further, the image forming velocity (line velocity) is not changed (Step S206; No, shown in FIG. 7), the image forming operation is performed thereafter, in such a state that the same magnification correction data is still applied (Step S204 shown in FIG. 7).

On the other hand, when the image forming operation is to be continued with respect to the same job or a different job (Step S205; Yes, shown in FIG. 7), and the image forming velocity (line velocity) is should be changed associating with the change of the thickness of the paper sheet (Step S206; Yes, shown in FIG. 7), the control section 101 implements the operations described as follows. Herein in the present embodiment, it is assumed that the recording paper sheet to be used is changed from the normal recording paper sheet to the thick paper sheet.

Initially, the control section 101 controls the polygon mirror driving motor 120M through the polygon mirror driving circuit 120D, so as to make the polygon mirror 120 rotate at 17716 rpm (hereinafter, defined as a “low speed rotation” in this embodiment), corresponding to the image forming velocity (line velocity) of 300 mm/sec., which is to be employed when the thick paper sheet is employed.

Successively, when the polygon mirror 120 has entered into such a stable state that the polygon mirror 120 is constantly rotated at 17716 rpm by the polygon mirror driving motor 120M, with respect to the laser beam reflected by each of the reflection surfaces of the polygon mirror 120, the time difference measuring section 150 measures the scanning time of the predetermined distance between the start-position light detecting section 140S1 and the end-position light detecting section 140S2, based on the time difference between the time detected by the start-position light detecting section 140S1 and the other time detected by the end-position light detecting section 140S2, according to the instruction commands issued by the control section 101. In this connection, on the abovementioned occasion, in order to distinguish the reflection surface of the polygon mirror 120, which is currently under the measurement, the detected result outputted by the position sensor 120S is also taken into account.

Still successively, based on the main-scanning time measured by the time difference measuring section 150, the magnification-correction data generating section 160 creates the magnification correction data for correcting the magnification factor in the main-scanning direction for every reflection surface of the polygon mirror 120, so as to keep the main-scanning length constant, corresponding to the image forming velocity of 300 mm/sec.

Still successively, the storage section 170 stores the magnification correction data, which has been created by the magnification-correction data generating section 160, so as to make it comply with the image forming velocity of 300 mm/sec for the thick recording paper sheet, corresponding to the low speed rotation of the polygon mirror 120, as the polygon-mirror magnification correction data for low speed rotation use (Step S207 shown in FIG. 7).

Still successively, the control section 101 reads out the magnification correction data corresponding to the image forming velocity in conformity with the thick paper sheet to be currently used for the image forming operation from the storage section 170, and makes the write clock generating section 180 generate the write clock signals, the clock frequency of which is adjusted by employing the magnification correction data above-read, and then, feeds the above-adjusted write clock signals to the LD drive circuit 110D and the image processing section 190, in order to implement the image forming operation in such a state that the positional intervals between the exposed dots, represented by the image data, are adjusted so as to keep the main-scanning length constant by eliminating the jitter components (Step S203 and Step S204 shown in FIG. 7).

Thereafter, at the time when accepting the request for implementing another image forming operation, the control section 101 repeats the consecutive operations indicated in Step S203 through Step S206, until the image forming apparatus 100 is deactivated or made to enter into the sleeping mode (END shown in FIG. 7). In this connection, after that, in the case that the image forming velocity (line velocity) should be changed in conjunction with the change of the thickness of the recording paper sheet (Step S206; Yes, shown in FIG. 7), it is applicable that the control section 101 uses the magnification correction data stored in advance, or newly creates the magnification correction data.

In this connection, according to OPERATING MODE 2 described in the above, since the magnification correction data is already acquired at the time when the rotation number of the polygon mirror 120 should be changed corresponding to the change of the image forming velocity, there arises such an advantageous merit that it becomes possible to acquire accurate magnification correction data, which timely matches with its using timing. Incidentally, since the time duration, required for implementing the operations for measuring the scanning time and calculating the magnification correction data, is relatively short time, compared to the other time duration required for changing the rotation number of the polygon mirror 120 and stabilizing the rotating action of the polygon mirror 120, there does not occur such an inconvenience that OPERATING MODE 2 consumes extremely long time compared to OPERATING MODE 1.

Further, in OPERATING MODE 2, the image forming apparatus 100 is so constituted that the magnification correction data in regard to the recording paper sheet, which tends to be frequently used in the operating environment of the image forming apparatus 100 concerned, is preferentially created first, and then, magnification correction data in regard to another recording paper sheet is created at the time when the frequently used recording paper sheet is to be changed to the other recording paper sheet concerned. Accordingly, in such an environment in which the thick paper sheets are frequently used, it is also applicable that the image forming operation is conducted by creating the magnification correction data in regard to the thick paper sheets concerned at the time when the power source of the image forming apparatus 100 is turned ON, and then, at the time when the change of the recording paper sheet has occurred, the other magnification correction data, in regard to the separate recording paper sheets (generally speaking, normal paper sheets), is created.

### <Other Embodiment (1)>

Incidentally, although the rotation number of the polygon mirror, which is in conjunction with the image forming velocity, changes in two steps in view of improvement of the fixing capability of the image forming apparatus described as the embodiment of the present invention in the foregoing, the scope of the present invention is not limited to the embodiments described in the foregoing. It is also applicable that the rotation number of the polygon mirror changes in three steps or more. Further, numerical values of the image forming velocity or the rotation number of the polygon mirror indicated in the present embodiments, described in the foregoing, are merely the exemplified numerical values. Even if various kinds of other values are employed for the abovementioned purpose, it is possible to attain a good result as far as the image forming apparatus is embodied in the present invention.

### <Other Embodiment (2)>

Although an image forming apparatus that employs the electro-photographic method using the laser beam has been exemplified as the embodiment of the present invention in the foregoing, the scope of the present invention is not limited to the embodiments described in the foregoing. Each of the embodiments of the present invention is also applicable for various kinds of image forming apparatuses, such as a laser imager that employs laser beam for conducting the exposing operation onto a photosensitive paper, etc., and it is possible to attain a good result.

### <Other Embodiment (3)>

Although the photoreceptor drum is employed as a concrete example of the photoreceptor member in the image forming apparatus exemplified as the embodiment of the present invention in the foregoing, the scope of the photoreceptor member is not limited to the drum-type photoreceptor member, but a belt-type photoreceptor member may be also applicable in the present invention. Further, the scope of the method for scanning the laser beam onto the photoreceptor member is not limited to such the method for rotating the photoreceptor drum in sub-scanning direction, various kinds of other sub-scanning methods for moving the laser beam relative to the photoreceptor member may be applicable in the present invention. Still further, in the case of the color image forming apparatus, the embodiment of the present invention is applicable for each of the polygon mirrors corresponding to each of the colors employed, so as to achieve the effects of the present invention.

As described in the foregoing, according to the present invention, the following effects can be attained.

In the image forming apparatus, embodied in the present invention, which is capable of conducting an image forming operation in any one of plural image forming modes, image forming velocities of which are different from each other, by changing both the scanning velocity in the main-scanning direction and the driving velocity in the sub-scanning direction, the magnification correction data, which is to be used for correcting the magnification factor in the main-scanning direction so as to keep the main-scanning length for every reflection surface of the polygon mirror constant, based on the result of measuring the time difference (main-scanning time) between the time when the laser beam is detected at the main-scanning start point and the other time when the laser beam is detected at the main-scanning stop point, is created and stored for every rotation number of polygon mirror, and then, the magnification correction data corresponding to the rotation number of polygon mirror is employed for adjusting the interval distances between exposed positions represented by the image data, so as to correct the magnification factor in the main-scanning direction.

According to the abovementioned feature, it becomes possible to effectively eliminate the deviations between the scanning line image lengths in the main-scanning direction, when the rotation velocity of the polygon mirror has been changed as a result of changing the image forming velocity. Accordingly, it becomes possible to form a uniform image without being influenced by the change of the image forming velocity.

Further, since the magnification factor in the main-scanning direction is corrected by adjusting the clock frequency of the clock signals to be employed for modulating the light beam based on the image data, it becomes possible to securely eliminate the deviations between the scanning line image lengths in the main-scanning direction, and accordingly, it becomes possible to form a uniform image without being influenced by the change of the image forming velocity.

Still further, since it is possible to securely eliminate the deviations between the scanning line image lengths in the main-scanning direction when plural light beams, which are aligned in the sub-scanning direction, and each of which is modulated based on corresponding one of main-scanning line image data sets representing main-scanning line images being adjacent to each other and included in the image data, it becomes possible to form a uniform image without being influenced by the change of the image forming velocity.

Still further, even when the driving velocity in the sub-scanning direction is changed in order to secure the thermal fixing operation to be conducted in the image forming apparatus concerned, it is possible to also cope with the rotation velocity of the polygon mirror, serving as the sub-scanning velocity to be changed in conjunction with the change of the driving velocity, and accordingly, it becomes possible to effectively eliminate the deviations between the scanning line image lengths in the main-scanning direction, when the rotation velocity of the polygon mirror has been changed as a result of changing the image forming velocity, and it becomes possible to form a uniform image without being influenced by the change of the image forming velocity.

Still further, since the light beam is detected by both the start-position light detecting section and the stop-position light detecting section, which are respectively arranged on the extension lines extended into the beginning side region and the ending side region from a main-scanning position of the image bearing member, in order to find the time difference between them (defined as a main-scanning time), it becomes possible to find the magnification correction data being more accurate than ever.

Still further, the image forming apparatus, embodied in the present invention, is provided with the reflection surface specifying section configured to specify an arbitral reflection surface among the reflection surfaces of the polygon mirror, so that, referring to a specific reflection surface specified by the reflection surface specifying section and synchronizing with a main-scanning timing of the specific reflection surface, the operation for creating the magnification correction data is implemented, so as to correct the magnification factor in the main-scanning direction by using the magnification correction data above-created. Therefore, it becomes possible to effectively eliminate the deviations between the scanning line image lengths in the main-scanning direction, when the rotation velocity of the polygon mirror has been changed as a result of changing the image forming velocity, and it becomes possible to form a uniform image without being influenced by the change of the image forming velocity.

Yet further, since the magnification correction data is created at the time when the scanning velocity in the main-scanning direction and the driving velocity in the sub-scanning direction have been changed, it becomes possible to effectively and securely eliminate the deviations between the scanning line image lengths in the main-scanning direction, when the rotation velocity of the polygon mirror has been changed as a result of changing the image forming velocity, and it becomes possible to form a uniform image without being influenced by the change of the image forming velocity.

While the preferred embodiments of the present invention have been described using specific term, such description is for illustrative purpose only, and it is to be understood that changes and variations may be made without departing from the spirit and scope of the appended claims.

What is claimed is:

1. An image forming apparatus provided with such an image forming function that an operation for exposing an image onto an image bearing member is conducted by scanning a light beam, which is modulated based on image data representing the image to be formed, onto the image bearing member in a main-scanning direction, while moving the image bearing member relative to the light beam in a sub-scanning direction orthogonal to the main-scanning direction, and the image forming apparatus being capable of conducting an image forming operation in any one of plural image forming modes, image forming velocities of which are different from each other, by changing both a scanning velocity in the main-scanning direction and a driving velocity in the sub-scanning direction, the image forming apparatus comprising:
a light source to emit the light beam;
a polygon mirror, having a plurality of reflection surfaces, to scan the light beam onto the image bearing member in the main-scanning direction by rotating the plurality of reflection surfaces;
a start-position light detecting section, disposed at a main-scanning start point located within a beginning side region of the main-scanning direction, to detect the light beam at the main-scanning start point;
a stop-position light detecting section, disposed at a main-scanning stop point located within an ending side region of the main-scanning direction, to detect the light beam at the main-scanning stop point;
a measuring section to measure a time difference between a time when the start-position light detecting section detects the light beam at the main-scanning start point and another time when the stop-position light detecting section detects the light beam at the main-scanning stop point, wherein the time difference is defined as a main-scanning time;
a magnification correction data creating section to create magnification correction data, which is to be used for correcting a magnification factor in the main-scanning direction so as to keep each of main-scanning lengths of the light beam, deflected by each of the reflection surfaces, constant, for every rotation number of the polygon mirror, based on the main-scanning time; and
a magnification factor correcting section to adjust interval distances between positions of exposed dots represented by the image data so as to correct the magnification factor in the main-scanning direction by using the magnification correction data corresponding to the rotation number of the polygon mirror.

2. The image forming apparatus of claim 1,
wherein the magnification factor correcting section adjusts a clock frequency of clock signals to be employed for modulating the light beam based on the image data, in order to adjust the interval distances between the positions of the exposed dots represented by the image data.

3. The image forming apparatus of claim 1,
wherein the light source is capable of emitting a plurality of light beams aligned in the sub-scanning direction; and
wherein each of the plurality of light beams is modulated based on corresponding one of main-scanning line image data sets, which represent main-scanning line images being adjacent to each other and are included in the image data.

4. The image forming apparatus of claim 1,
wherein the scanning velocity in the main-scanning direction is determined by a rotation velocity of the polygon mirror, while the rotation velocity is determined corresponding to the driving velocity in the sub-scanning direction.

5. The image forming apparatus of claim 1,
wherein the main-scanning start point, at which the start-position light detecting section detects the light beam, is arranged on an extension line extended into the beginning side region from a main-scanning position of the image bearing member, and the main-scanning stop point, at which the stop-position light detecting section detects the light beam, is arranged on another extension line extended into the ending side region from the main-scanning position of the image bearing member.

6. The image forming apparatus of claim 1, further comprising:
a reflection surface specifying section configured to specify an arbitral reflection surface among the reflection surfaces of the polygon mirror;
wherein, referring to a specific reflection surface specified by the reflection surface specifying section and synchronizing with a main-scanning timing of the specific reflection surface, the magnification correction data creating section creates the magnification correction data, and then, the magnification factor correcting section corrects the magnification factor in the main-scanning direction by using the magnification correction data.

7. The image forming apparatus of claim 1,
wherein the magnification correction data creating section creates the magnification correction data, when the scanning velocity in the main-scanning direction and the driving velocity in the sub-scanning direction are changed.
